(19) United States
(12) Patent Application Publication
(10) Pub. No.: US 2017/0031268 A1
(43) Pub. Date: Feb. 2, 2017

(54) DEVELOPING DEVICE AND IMAGE FORMING APPARATUS

(71) Applicant: Oki Data Corporation, Tokyo (JP)

(72) Inventor: Kenji KOIDO, Tokyo (JP)

(73) Assignee: Oki Data Corporation, Tokyo (JP)

(21) Appl. No.: 15/214,785

(22) Filed: Jul. 20, 2016

(30) Foreign Application Priority Data
Jul. 31, 2015 (JP) 2015-151483

(51) Int. Cl. G03G 15/08

(52) U.S. Cl. CPC G03G 15/0812

(57) ABSTRACT

A developing device includes: a latent image carrier on which an electrostatic latent image is formed; a developer carrier that supplies the latent image carrier with developer to develop the latent image formed on the latent image carrier; and a regulating member that forms a thin layer of the developer on the developer carrier. The developer includes a release agent. An endothermic amount of the release agent in the developer is from 1.87 mJ/mg to 2.51 mJ/mg inclusive. A proportion of particles having particle sizes not greater than 3.021 μm in the developer is from 0% to 21.76% by number inclusive.

### BACKGROUND OF THE INVENTION

1. Field of the Invention

The present invention relates to a developing device and an image forming apparatus, such as a copier, a facsimile machine, or a printer, including the developing device.

2. Description of the Related Art

Japanese Patent Application Publication No. 2009-276660 discloses an image forming apparatus including a developer supplier for supplying developer to an electrostatic latent image and a developer container, the developer supplier initially containing a first developer, the developer container supplying the developer supplier with a second developer having a glass transition temperature lower than that of the first developer.

### SUMMARY OF THE INVENTION

An aspect of the present invention is intended to improve image quality.

According to an aspect of the present invention, there is provided a developing device including: a latent image carrier on which an electrostatic latent image is formed; a developer carrier that supplies the latent image carrier with developer to develop the latent image formed on the latent image carrier; and a regulating member that forms a thin layer of the developer on the developer carrier. The developer includes a release agent. An endothermic amount of the release agent in the developer is from 1.87 mJ/mg to 2.51 mJ/mg inclusive. A proportion of particles having particle sizes not greater than 3.021 μm in the developer is from 0% to 21.76% by number inclusive.

According to another aspect of the present invention, there is provided a developing device including: a latent image carrier on which an electrostatic latent image is formed; a developer carrier that supplies the latent image carrier with developer to develop the latent image formed on the latent image carrier; and a regulating member that forms a thin layer of the developer on the developer carrier. The developer includes a release agent. An endothermic amount of the release agent in the developer is from 1.87 mJ/mg to 2.51 mJ/mg inclusive. A proportion of particles having particle sizes not greater than 1.977 μm in the developer is from 0% to 19.62% by number inclusive.

According to another aspect of the present invention, there is provided an image forming apparatus including: any one of the above developing devices; a transfer unit that transfers the developer supplied to the latent image carrier onto a recording medium; and a fixing unit that fixes the transferred developer to the recording medium.

### BRIEF DESCRIPTION OF THE DRAWINGS

In the attached drawings:

FIG. 1 is a schematic diagram illustrating the main components of an image forming apparatus according to an embodiment of the present invention;

FIG. 2 is a diagram schematically illustrating a configuration of an image forming unit together with an LED head, a transfer roller, and a recording paper sheet;

FIG. 3 is an enlarged view of a part of FIG. 2 illustrating a developing blade together with a developing roller for explaining the shape and mounting conditions of the developing blade;

FIG. 4 is a block diagram illustrating the main components of a control system of the image forming apparatus;

FIGS. 5A and 5B are endothermic curve graphs illustrating an endothermic curve of a toner J, FIG. 5A illustrating the endothermic curve in the range of 20° C. to 200° C., FIG. 5B being an enlarged graph of a part of the endothermic curve around an endothermic peak at 83° C.;

FIG. 6 is a diagram used for explaining a proportion of particles;

FIG. 7 is a table showing results of a filming test;

FIG. 8 is a graph plotting results of the filming test in a coordinate system having a horizontal axis representing the amount of fine particles having particle sizes not greater than 3.021 μm and a vertical axis representing a DSC endothermic amount; and

FIG. 9 is a graph plotting results of the filming test in a coordinate system having a horizontal axis representing the amount of fine particles having particle sizes not greater than 1.977 μm and a vertical axis representing the DSC endothermic amount.

### DETAILED DESCRIPTION OF THE INVENTION

An embodiment of the present invention will now be described with reference to the attached drawings.

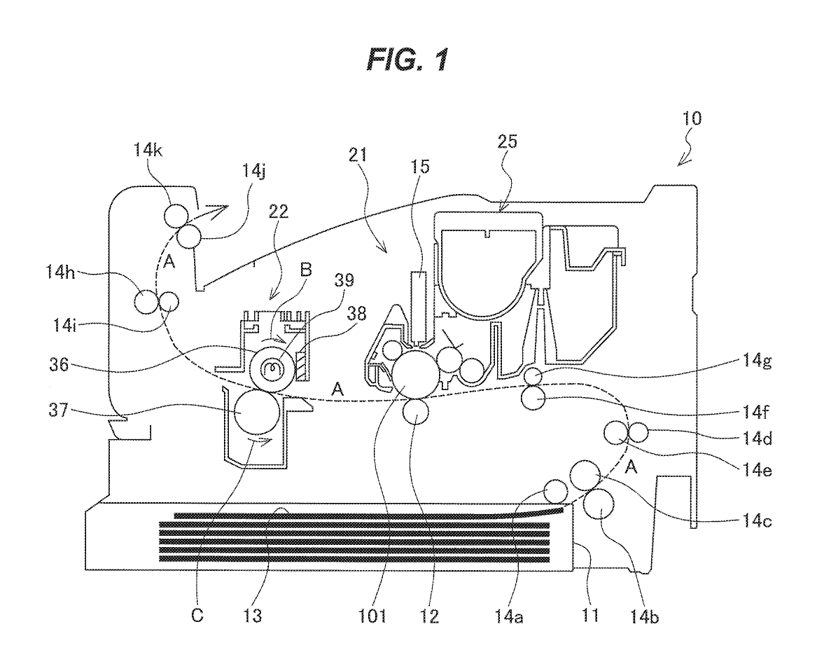

FIG. 1 is a schematic diagram illustrating the main components of an image forming apparatus 10 according to the embodiment.

The image forming apparatus 10 is a monochrome electrophotographic printer and includes, as illustrated in FIG. 1, a recording paper cassette 11, an image forming portion 21, a fixing device 22, and sheet conveying rollers 14a to 14k for conveying a recording paper sheet (referred to below simply as a sheet) 13 as a transfer medium or recording medium.

The recording paper cassette 11 stores sheets 13 therein in a stacked manner. The recording paper cassette 11 is detachably attached to a lower portion of the image forming apparatus 10. The sheet conveying roller 14a picks up the sheets 13 stored in the recording paper cassette 11 from the top thereof one by one and feeds the picked-up sheet 13 along a sheet conveying path in the direction indicated by dashed arrow A in FIG. 1. The sheet conveying rollers 14b to 14g convey the sheet 13 to the image forming portion 21 along the direction of dashed arrow A in FIG. 1 while correcting skew of the sheet 13.

The dashed arrow A in FIG. 1 schematically indicates the conveying path of the sheet 13 as well as the conveying direction of the sheet 13.

The image forming portion 21 includes an image forming unit 25 detachably disposed in a main body of the image forming apparatus 10 along the sheet conveying path, a light emitting diode (LED) head 15 as an exposure device, and a transfer roller 12 that transfers a toner image formed by the image forming unit 25 as described later onto an upper surface of the sheet 13 by coulomb force.

The transfer roller 12 is disposed in pressure contact with a photosensitive drum 101 in the image forming unit 25. The transfer roller 12 conveys the fed sheet 13 along dashed arrow A and is applied with a voltage for transferring a toner image formed on the photosensitive drum 101 onto the sheet 13, as described later.

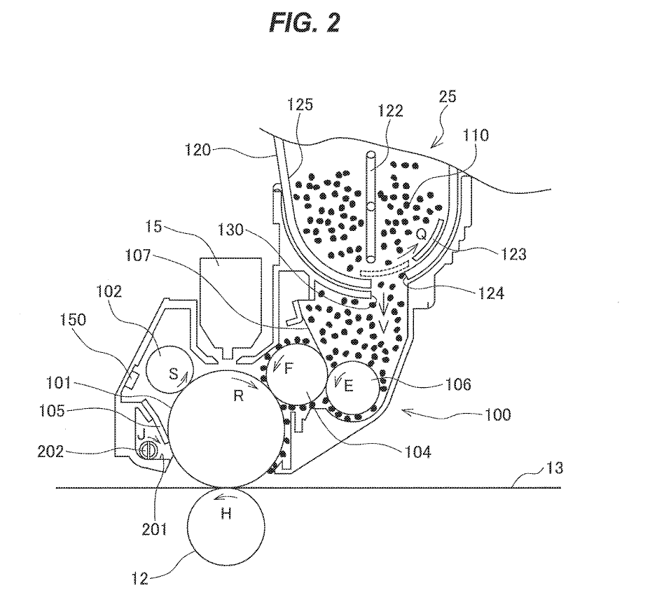

Next, the configuration of the image forming unit 25 will be described. FIG. 2 is a diagram schematically illustrating the main components of the image forming unit 25 together with the LED head 15, transfer roller 12, and sheet 13.

As illustrated in FIG. 2, the image forming unit 25 includes a developing unit 100, a toner cartridge 120 as a developer container for storing toner 110 as developer, the photosensitive drum 101 as a latent image carrier, a charging roller 102 as a charging member (or latent image carrier charging member), a cleaning blade 105 as a cleaning member that is pressed against a peripheral surface of the photosensitive drum 101, and discharge light source 150. The developing unit 100 includes a developing roller 104 as a developer carrier, a supplying roller 106 as a supplying member, and a developing blade 107 as a regulating member (or developer layer regulating member). The image forming unit 25 is detachably disposed at a predetermined position in the image forming apparatus 10 (FIG. 1). The toner cartridge 120 is detachably attached to the developing unit 100. In FIG. 2, illustration of an upper part of the toner cartridge 120 is omitted.

The photosensitive drum 101, charging roller 102, developing roller 104, toner cartridge 120, and developing blade 107 constitutes a developing device.

The photosensitive drum 101 is, for example, an inorganic photosensitive drum including a conductive base roller made of aluminum or the like and a photosensitive layer of selenium, amorphous silicon, or the like formed on the base roller, or an organic photosensitive drum including a conductive base roller made of aluminum or the like and an organic photosensitive layer formed on the base roller by dispersing a charge generation material and a charge transport material in a binder resin. In this embodiment, the photosensitive drum 101 is composed of a conductive support and a photoconductive layer. Specifically, the photosensitive drum 101 is an organic photoreceptor having a metal pipe made of aluminum as the conductive support and a charge generation layer and a charge transport layer sequentially laminated on the metal pipe as the photoconductive layer. The aluminum pipe has an outer diameter of 30 mm, and the photoconductive layer has a thickness of 20 μm. The photosensitive drum 101 rotates in the rotational direction indicated by arrow R in FIG. 2.

The charging roller 102 is disposed in contact with the peripheral surface of the photosensitive drum 101. The charging roller 102 includes a metal shaft and a semiconductive epichlorohydrin rubber layer. The LED head 15 includes, for example, LED elements and a lens array. The LED head 15 is disposed so that illumination light emitted from the LED elements is focused on the surface of the photosensitive drum 101.

The developing roller 104 is disposed in contact with the peripheral surface of the photosensitive drum 101. The developing roller 104 includes, for example, a conductive base shaft made of stainless steel or the like and a rubber layer. The rubber layer may be made of silicone rubber, urethane rubber, or other materials commonly used for developing rollers. The developing roller 104 may include carbon or other materials for adjusting the electrical resistance or other properties of the developing roller 104. In this embodiment, the rubber layer is a semiconductive urethane rubber layer.

The rubber hardness of the rubber layer is set in consideration of reduction in damage to the toner in high speed printing. In this embodiment, the rubber layer has a rubber hardness of 52° when measured by a hardness tester (Micro durometer MD-1, manufactured by Kobunshi Keiki Co., Ltd.). The rubber hardness is measured by Type A durometer specified in Japanese Industrial Standard (JIS) K 6253 as follows. An indentor is pressed against a surface of a sample by force of a spring to deform the sample; the hardness is measured based on the depth of indentation of the indentor in a state where the resistive force of the sample and the force of the spring balance with each other; the maximum value of the hardness is read using a peak hold function in an automatic measurement.

In this embodiment, the rubber layer has a volume resistance of 1×10⁷ Ωcm and a surface roughness Rz of 8.0 μm.

In this embodiment, the developing roller 104 has a diameter of 16.0 mm, and is disposed so that a portion where the developing roller 104 abuts the photosensitive drum 101 has a width of 2.00 mm.

The supplying roller 106 is in sliding contact with the developing roller 104. The supplying roller 106 includes, for example, a conductive base shaft made of stainless steel or the like and an elastic layer. The elastic layer may be a semiconductive foamed silicone sponge layer, semiconductive foamed urethane sponge layer, or other members commonly used for supplying rollers. In this embodiment, the elastic layer is a semiconductive foamed silicone sponge layer. The supplying roller 106 has a diameter of 15.5 mm.

In this embodiment, in view of abrasion during printing, the elastic layer has an Asker F hardness of 40 to 70 degrees (JIS Z2245). In view of current flowing during printing, the elastic layer preferably has a volume resistance of 1×10⁵ to 1×10⁸ Ωcm. The volume resistance is measured by pressing a metal cylinder against the elastic layer with a force of 300 gf and applying −300 V to the elastic layer.

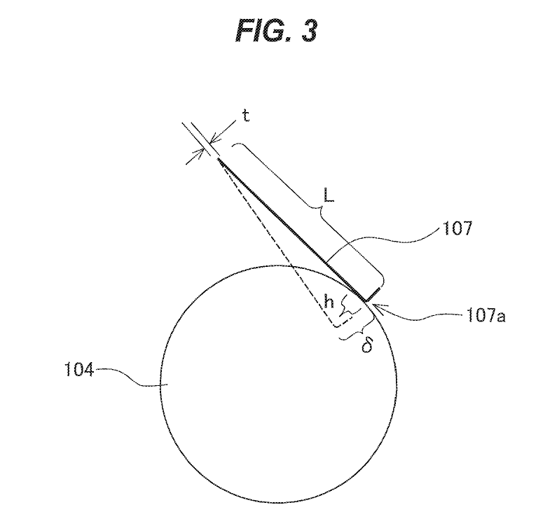

FIG. 3 is an enlarged view of a part of FIG. 2 for explaining the shape and mounting conditions of the developing blade 107. FIG. 3 illustrates the developing blade 107 together with the developing roller 104. In FIG. 3, the dashed line represents the developing blade 107 in a natural state where the developing blade 107 is not in contact with the developing roller 104.

As illustrated in FIG. 3, the developing blade 107 has an R portion (or round portion) 107a with a radius of curvature of 0.21 mm formed by bending a leading end of the developing blade 107 at substantially 90 degrees. The R portion 107a is in pressure contact with a surface of the developing roller 104. The developing blade 107 is made of metal such as stainless steel or phosphor bronze, rubber material such as silicone rubber, or other materials. The developing blade 107 is applied with a voltage as needed.

If a pressure P at which the developing blade 107 is pressed against the developing roller 104 is too high, the toner layer is thin and formed insufficiently, resulting in reduction in image density or damage to the surface of the developing roller 104. If the pressure P is too low, the toner layer is unstable, resulting in a poor image including high density portions and low density portions. To stably maintain the toner layer, the pressure P preferably satisfies:

16.3 kPa≦P≦35.8 kPa,

and more preferably satisfies:

21.7 kPa≦P≦32.5 kPa.

When the developing blade 107 is made of metal, the pressure P (Pa) is given by:

P=(E×t³×δ×h)/(4L³)

where L (mm) is the effective length of the developing blade 107, δ (mm) is the amount of deflection of the developing blade 107, h (mm) is the length of a portion where the developing blade 107 abuts the developing roller 104, E (Pa) is the longitudinal elastic modulus of the developing blade 107, and t is the thickness of the developing blade 107, as illustrated in FIG. 3. When δ=2.6 mm, L=13.0 mm, h=1.0 mm, t=0.08 mm, and the developing blade 107 is made of SUS304B and thus E=186.2×10⁹ Pa, P=28205 Pa≈28.2 kPa.

Referring to FIG. 2, the cleaning blade 105 is made of, for example, polyurethane rubber. The cleaning blade 105 has a leading end that is oriented in a direction opposite to the rotational direction (direction of arrow R) of the photosensitive drum 101 and is in sliding contact with the peripheral surface of the photosensitive drum 101. The cleaning blade 105 has a function of scrapping off matter adhering to the peripheral surface of the photosensitive drum 101. In this embodiment, the cleaning blade 105 is formed of a rubber elastic body having, for example, the following physical properties: a hardness (JIS A scale) of about 75°, a 300% modulus of about 400 kgf/cm², a tensile strength of about 650 kgf/cm², an impact resilience at 23° C. of about 20%, a tensile elasticity of about 70 kgf/cm², and a friction coefficient of about 1.

The cleaning blade 105 has the other end opposite the leading end. The cleaning blade 105 is bonded to a sheet metal holder with a hot-melt adhesive, thereby being fixed to a main body of the image forming unit 25. The cleaning blade 105 and sheet metal holder both extend in a longitudinal direction. In the longitudinal direction, the sheet metal holder has substantially the same length as the cleaning blade 105. The sheet metal holder is formed by bending a metal plate into a dogleg shape. After the cleaning process, the discharge light source 150 irradiates the photosensitive drum 101 with discharge light to discharge the surface of the photosensitive drum 101.

The toner cartridge 120 includes a developer storing portion 125 for storing the toner 110, an agitating bar 122 for agitating the toner 110 in the developer storing portion 125, a discharge opening 124 for discharging the toner 110 in the developer storing portion 125, and a shutter 123 for opening and closing the discharge opening 124. The agitating bar 122 is rotatably supported in the developer storing portion 125 and extends in its longitudinal direction. The discharge opening 124 is formed below the agitating bar 122. The shutter 123 is disposed slidably in the direction of arrow Q to open and close the discharge opening 124.

Referring to FIG. 1, a sheet 13 on which a toner image has been transferred by the image forming portion 21 as described later is conveyed on the conveying path in the direction of dashed arrow A in FIG. 1 to the fixing device 22. The fixing device 22 includes a fixing roller 36, a pressure roller 37, a thermistor 38, and a heater 39.

The fixing roller 36 is formed by coating a hollow cylindrical metal core made of aluminum with tetrafluoroethylene-perfluoro alkylvinylether copolymer (PFA). The initial surface roughness Ra of the fixing roller 36 after the coating preferably satisfies:

0.1Dt≦Ra≦2.5Dt,

more preferably satisfies:

0.6Dt≦Ra≦2.5Dt,

and still more preferably satisfies:

1.1Dt<Ra≦2.5Dt,

where Dt is the initial volume average particle size of the toner.

If the initial surface roughness Ra of the fixing roller is too small relative to the initial volume average particle size Dt, when the toner is melted in the fixing process, the toner is in close contact with the fixing roller 36 with almost no space therebetween, deteriorating releasability. Thus, hot offset or winding of a sheet 13 around the fixing roller 36 is likely to occur. The hot offset is a phenomenon that some of the melted toner on a sheet 13 adheres to the fixing roller 36 due to excess heat. If the initial surface roughness Ra of the fixing roller is too large relative to the initial volume average particle size Dt, heat is not sufficiently transferred from the fixing roller 36 to the toner, weakening adhesion between the sheet 13 and the toner. Thus, cold offset is likely to occur. The cold offset is a phenomenon that some of the melted toner on a sheet 13 adheres to the fixing roller 36 due to insufficient heat. To maintain good fixing properties, it is preferable that the relationship between the surface roughness Ra of the fixing roller and the volume average particle size Dt of the toner be set as above. The heater 39 is disposed as a heat source in the metal core of the fixing roller 36. The heater 39 is, for example, a halogen lamp.

The pressure roller 37 includes a metal core made of aluminum, a heat-resistant elastic layer made of silicone rubber covering the metal core, and a PFA tube covering the elastic layer. The pressure roller 37 is disposed to form a pressure contact portion (or nip portion) between the pressure roller 37 and the fixing roller 36. The thermistor 38 is a sensor for detecting a temperature of a surface of the fixing roller 36. The thermistor 38 is disposed near the fixing roller 36 in a non-contact manner. The thermistor 38 transmits temperature information indicating the detected temperature to a temperature controller described later. The temperature controller performs ON/OFF control of the heater 39 based on the temperature information to maintain the surface temperature of the fixing roller 36 at a predetermined temperature.

Next, the toner 110, which is used as developer in this embodiment, will be described. The toner 110 includes toner base particles containing at least a binder resin and an external additive, such as an inorganic powder or an organic powder, added to the toner base particles. The toner 110 is stored in the toner cartridge 120.

The binder resin is preferably, but not limited to, a polyester resin, a styrene-acrylic resin, an epoxy resin, or a styrene-butadiene resin. The binder resin is added with a release agent, a colorant, or the like. In addition, the binder resin may be added with additives, such as a charge control agent, a conductivity conditioner, a flow improver, or a cleaning property improver, as needed. In this embodiment, a polyester resin is used as the binder resin.

Examples of the release agent include, but are not limited to, paraffin wax, carnauba wax, and other known materials, which may be used alone or in combination. In this embodiment, a carnauba wax having a melting point of 83° C. is used as the release agent. 0.1 to 20 parts by weight, preferably 0.5 to 12 parts by weight, of carnauba wax is added to 100 parts by weight of binder resin.

Examples of the colorant include, but are not limited to, dye, pigment, and other materials used as toner colorant, which may be used alone or in combination. For example, carbon black or iron oxide may be used for black toner, and known colorants may be used for color toner. In this embodiment, carbon black is used as the colorant. 2 to 25 parts by weight, preferably 2 to 15 parts by weight, of colorant is added to 100 parts by weight of binder resin.

Examples of the charge control agent include an azo complex charge control agent, a salicylic acid complex charge control agent, a calixarene charge control agent, a quaternary ammonium salt charge control agent, and other known materials, which may be used alone or in combination. 0.05 to 15 parts by weight, preferably 0.1 to 10 parts by weight, of charge control agent is added to 100 parts by weight of binder resin.

The external additive is added to improve environmental stability, charge stability, developing properties, fluidity, storage stability of the toner. As the external additive, known materials may be used alone or in combination. In this embodiment, silica is used as the external additive. 0.01 to 10 parts by weight, preferably 0.05 to 8 parts by weight, of external additive is added to 100 parts by weight of binder resin.

In one example, the toner 110 is manufactured by the following manufacturing method. 100 parts by weight of binder resin (polyester resin), 0.5 parts by weight of Bontron E84 (manufactured by ORIENT CHEMICAL INDUSTRIES CO., LTD.) as the charge control agent, 5.0 parts by weight of carbon black as the colorant, and 3.0 parts by weight of carnauba wax (Carnauba Wax No. 1 powder, manufactured by S. Kato & CO.) as the release agent are mixed using Henschel mixer. Then, the mixture is melted and kneaded with a twin screw extruder. After cooled, the kneaded product is roughly pulverized with a cutter mill with a screen having a diameter of 2 mm and is then pulverized with an impact type mill (“Dispersion Separator”, manufactured by Nippon Pneumatic Mfg. Co., Ltd.). Further, the pulverized product is classified using a pneumatic classifier (Elbow Jet, manufactured by Nittetsu Mining Co., Ltd.), so that toner base particles having an average particle size of 7.0 μm. After that, in an external addition process, 2.0 parts by weight of hydrophobic silica R972 (manufactured by Nippon Aerosil Co., Ltd., having an average particle size of 16 nm) is added to 100 parts by weight (1 kg) of the obtained toner base particles, and stirred for 3 minutes with a Henschel mixer, so that negatively chargeable toner is obtained.

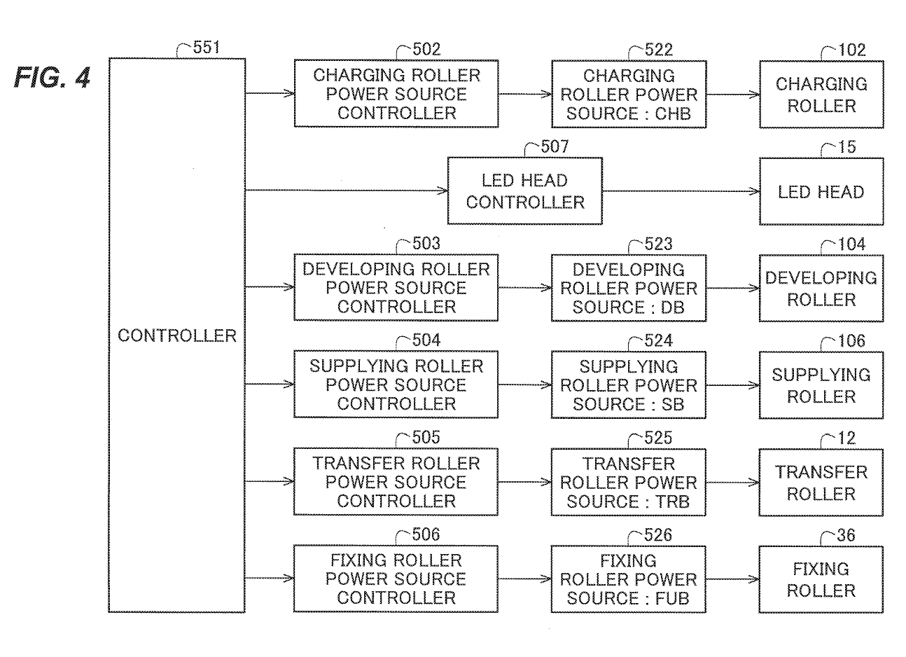

FIG. 4 is a block diagram illustrating the main components of a control system of the image forming apparatus 10. The control system will be described below with reference to FIGS. 1, 2, and 4.

In FIG. 4, the control system includes a controller 551, a charging roller power source controller 502, an LED head controller 507, a developing roller power source controller 503, a supplying roller power source controller 504, a transfer roller power source controller 505, and a fixing roller power source controller 506.

The controller 551 includes a microprocessor, a read only memory (ROM), a random access memory (RAM), an input-output port, a timer, and the like. The controller 551 receives print data and control commands from a host device (not illustrated) and controls the entire image forming apparatus 10 to print the print data in accordance with the control commands.

The charging roller power source controller 502 performs, in accordance with instructions from the controller 551, an application voltage control to apply a voltage to the charging roller 102 to charge the surface of the photosensitive drum 101 (FIG. 2). The LED head controller 507 performs, in accordance with instructions from the controller 551, an exposure control to irradiate the charged surface of the photosensitive drum 101 (FIG. 2) with light emitted from the LED head 15 (FIG. 1) in accordance with the print data to form an electrostatic latent image on the photosensitive drum 101. The developing roller power source controller 503 performs, in accordance with instructions from the controller 551, an application voltage control to apply a voltage to the developing roller 104 to cause the toner to adhere to the electrostatic latent image formed on the surface of the photosensitive drum 101 (FIG. 1) by the LED head 15. The supplying roller power source controller 504 performs, in accordance with instructions from the controller 551, an application voltage control to apply a voltage to the supplying roller 106 to supply the toner to the developing roller 104 (FIG. 2). The transfer roller power source controller 505 performs, in accordance with instructions from the controller 551, an application voltage control to apply a voltage to the transfer roller 12 (FIG. 1) to transfer a toner image formed on the surface of the photosensitive drum 101 onto a sheet 13 as a print medium. The fixing roller power source controller 506 serves as the temperature controller. The fixing roller power source controller 506 performs, in accordance with instructions from the controller 551, a temperature control to maintain the surface temperature of the fixing roller 36 at the predetermined temperature based on the temperature information from the thermistor 38 (FIG. 1) for measuring the temperature of the fixing roller 36.

In FIG. 4, the control system also includes a charging roller power source (CHB) 522, a developing roller power source (DB) 523, a supplying roller power source (SB) 524, a transfer roller power source (TRB) 525, and a fixing roller power source (FUB) 526.

The charging roller power source (CHB) 522 applies a direct-current voltage to the charging roller 102 under the application voltage control of the charging roller power source controller 502. The developing roller power source (DB) 523 applies a direct-current voltage to the developing roller 104 under the application voltage control of the developing roller power source controller 503, thereby forming a toner image on the photosensitive drum 101 exposed by the LED head 15. The supplying roller power source (SB) 524 applies a direct-current voltage to the supplying roller 106 under the application voltage control of the supplying roller power source controller 504. The transfer roller power source (TRB) 525 applies a direct-current voltage to the transfer roller 12 under the application voltage control of the transfer roller power source controller 505, thereby transferring a toner image formed by the image forming unit 25 onto a sheet 13. The fixing roller power source (FUB) 526 on/off drives the heater 39 under the temperature control of the fixing roller power source controller 506.

Next, the operation of the image forming apparatus 10 will be described with reference to FIGS. 1, 2, and 4.

As illustrated in FIG. 2, the photosensitive drum 101 is rotated by a driving unit (not illustrated) in the direction of arrow R in FIG. 2 at a constant peripheral speed. The charging roller 102, which is disposed in contact with the surface of the photosensitive drum 101, applies the surface of the photosensitive drum 101 with a direct-current voltage supplied from the charging roller power source (CHB) 522 (FIG. 4) while rotating in the direction of arrow S in FIG. 2, thereby uniformly charging the surface of the photosensitive drum 101 to, for example, about −640 V. The charging roller 102 rotates in the direction opposite to the rotational direction of the photosensitive drum 101. The ratio between the peripheral speed of the charging roller 102 and that of the photosensitive drum 101 is 1:1. That is, the peripheral speed of the charging roller 102 is the same as that of the photosensitive drum 101.

Then, the LED head 15, which is disposed facing the photosensitive drum 101, illuminates the uniformly charged surface of the photosensitive drum 101 with light corresponding to an image signal to attenuate the potential at illuminated portions to −100 V, thereby forming an electrostatic latent image.

Before the toner cartridge 120 is attached to the developing unit 100, the discharge opening 124 of the toner cartridge 120 is closed by the shutter 123, as indicated by the dashed line in FIG. 2. After the toner cartridge 120 is attached to the developing unit 100, a lever (not illustrated) is operated to slide the shutter 123 in the direction of arrow Q and open the discharge opening 124. Thereby, the toner 110 in the developer storing portion 125 falls through the discharge opening 124 in the direction of arrow V and is supplied to the developing unit 100 through a toner supply opening 130 formed in an upper portion of a main body (the part except the toner cartridge 120) of the image forming unit 25.

The toner 110 supplied to the developing unit 100 is conveyed and supplied to the developing roller 104 by the supplying roller 106, which is applied with a direct-current voltage by the supplying roller power source (SB) 524 (FIG. 4) and rotates in the direction of arrow E. The supplying roller 106 rotates in the same direction as the developing roller 104. The peripheral speed of the supplying roller 106 is 0.5 to 0.8 times the peripheral speed of the developing roller 104. If the peripheral speed of the supplying roller 106 is less than 0.5 times the peripheral speed of the developing roller 104, the toner is not sufficiently supplied to the developing roller 104, resulting in image blur. If the peripheral speed of the supplying roller 106 is greater than 0.8 times the peripheral speed of the developing roller 104, the supplying roller 106 is worn rapidly, leading to poor toner supply, resulting in image blur. In this embodiment, the peripheral speed of the supplying roller 106 is 0.66 times the peripheral speed of the developing roller 104.

The developing roller 104 is disposed in close contact with the photosensitive drum 101 and applied with a direct-current voltage by the developing roller power source (DB) 523 (FIG. 4). The developing roller 104 holds the toner 110 conveyed by the supplying roller 106 and rotates in the direction of arrow F in FIG. 2 to convey the toner 110. When the toner 110 is rotationally conveyed, the developing blade 107, which is disposed downstream of the supplying roller 106 in pressure contact with the developing roller 104, regulates the toner 110 carried on the developing roller 104 to form a toner layer having a uniform thickness on the developing roller 104. To obtain a printed image having an appropriate density, the amount of the toner layer is set to 0.30 to 0.60 mg/cm². The toner on the developing roller 104 is charged by friction due to sliding between the developing roller 104 and the supplying roller 106, pressure contact with the developing blade 107, or other reasons.

The developing roller 104 rotates in the direction opposite to the rotational direction of the photosensitive drum 101. The peripheral speed of the developing roller 104 is 1.1 to 1.4 times the peripheral speed of the photosensitive drum 101. If the peripheral speed of the developing roller 104 is less than 1.1 times the peripheral speed of the photosensitive drum 101, the toner is not sufficiently charged and thus fog is likely to occur. If the peripheral speed of the developing roller 104 is greater than 1.4 times the peripheral speed of the photosensitive drum 101, the surface of the photosensitive drum 101 is abraded significantly. In this embodiment, the peripheral speed of the developing roller 104 is 1.26 times the peripheral speed of the photosensitive drum 101. An electrostatic latent image formed on the photosensitive drum 101 is developed by the toner 110 carried on the developing roller 104.

A bias voltage is applied by the developing roller power source (DB) 523, which is a high-voltage power supply, between the photosensitive drum 101 and the developing roller 104, causing lines of electric force due to the electrostatic latent image formed on the photosensitive drum 101 between the developing roller 104 and the photosensitive drum 101. Thus, the charged toner 110 on the developing roller 104 adheres to the electrostatic latent image on the photosensitive drum 101 due to electrostatic force, thereby developing the electrostatic latent image to form a toner image. This developing process is started at a predetermined time described later.

Referring to FIG. 1, the sheets 13 stored in the recording paper cassette 11 are picked up one by one from the recording paper cassette 11 by the sheet conveying roller 14a in the direction of dashed arrow A in FIG. 1. Then, the sheet 13 is conveyed by the sheet conveying rollers 14b to 14g in the direction of dashed arrow A along a recording paper sheet guide (not illustrated) while skew of the sheet 13 is corrected, and fed to the image forming portion 21, which includes the image forming unit 25 and transfer roller 12. The above-described developing process is started at a predetermined time while the sheet 13 is conveyed in the direction of dashed arrow A.

In the image forming portion 21, as illustrated in FIG. 2, the transfer roller 12 is disposed in pressure contact with the photosensitive drum 101 of the image forming unit 25. The transfer roller 12 is applied with a direct-current voltage (e.g., +2000 V) by the transfer roller power source (TRB) 525 (FIG. 4) and rotates in the direction of arrow H. The transfer roller 12 transfers the toner image formed on the photosensitive drum 101 in the above developing process onto the sheet 13. This process is referred to as the transfer process.

The sheet 13 with the toner image transferred thereon is then conveyed to the fixing device 22, which includes the fixing roller 36 and pressure roller 37. The sheet 13 with the toner image transferred thereon enters between the fixing roller 36, whose surface is maintained at the predetermined temperature by the temperature control and which rotates in the direction of arrow B in FIG. 1, and the pressure roller 37, which rotates in the direction of arrow C in FIG. 1. The fixing roller 36 applies heat to the toner image on the sheet 13 to melt the toner image, and the pressure roller 37 applies pressure to the melted toner image on the sheet 13 in the pressure contact portion between the fixing roller 36 and the pressure roller 37, thereby fixing the toner image onto the sheet 13. The sheet 13 with the toner image fixed thereon is conveyed by the sheet conveying rollers 14h to 14k in the direction of dashed arrow A in FIG. 1 and discharged outside the image forming apparatus 10.

After the electrostatic latent image on the photosensitive drum 101 is developed by the developing roller 104, the toner 110 remaining on the developing roller 104 without being used in the development is conveyed with the rotation of the developing roller 104 to a contact portion where the developing roller 104 abuts the supplying roller 106, and is collected by the supplying roller 106. The toner 110 newly supplied through the discharge opening 124 is fed to the supplying roller 106 on the downstream side of the developing roller 104 in the direction of rotation of the supplying roller 106, and further fed to the developing roller 104. As such, the developing process is performed repeatedly.

After the transfer, a small amount of toner 110 may remain on the surface of the photosensitive drum 101 without being transferred. This remaining toner 110 is removed by the cleaning blade 105. As illustrated in FIG. 2, the cleaning blade 105 is disposed parallel to an axis of rotation of the photosensitive drum 101. The cleaning blade 105 has the leading end and the other end (or base portion). The base portion is attached and fixed to the sheet metal holder, which is a rigid support substrate, so that the leading end abuts the surface of the photosensitive drum 101. The photosensitive drum 101 rotates in the direction of arrow R while the cleaning blade 105 abuts the peripheral surface of the photosensitive drum 101. Thereby, the residual toner 110 remaining on the surface of the photosensitive drum 101 without being transferred is removed from the photosensitive drum 101. The cleaned photosensitive drum 101 is rotated and used repeatedly.

The residual toner removed from the photosensitive drum 101 is toner that has not been transferred from the photosensitive drum 101 onto the sheet 13, and includes many toner particles whose chargeability is too high or low as compared to toner that has been transferred onto the sheet 13. Further, the residual toner may include many external additive particles that have not been transferred onto the sheet 13. Thus, compared to toner before being subjected to the transfer process, since the residual toner includes many toner particles having high or low chargeability, particles in the residual toner tend to electrostatically clump together and have poor fluidity.

The residual toner removed from the photosensitive drum 101 by the cleaning blade 105 is stored in a residual toner storing portion 201 below the cleaning blade 105. A residual toner conveying screw 202 is disposed along the cleaning blade 105 in the residual toner storing portion 201. The residual toner conveying screw 202 rotates in the direction of arrow J to convey the stored residual toner in one direction and discharge it outside the image forming unit 25.

Toners were prepared as test samples and tested for filming and fixability as described below.

Twenty-one types of toners A to U were obtained by the above-described manufacturing method by varying classification conditions in the classification process.

For the obtained toner J, the endothermic amount of the release agent (peak temperature: 83° C.) was measured using a differential scanning calorimeter (D5C6220, manufactured by SII Nano Technology Inc.) under the following conditions.

Amount of toner used for measurement: 5 mg

Measurement method: second-run method

Start temperature: 20° C., End temperature: 200° C., Rate of temperature increase: 10° C./min, Rate of temperature decrease: 90° C./min

The measurement revealed that the endothermic amount of the release agent was 2.21 mJ/mg.

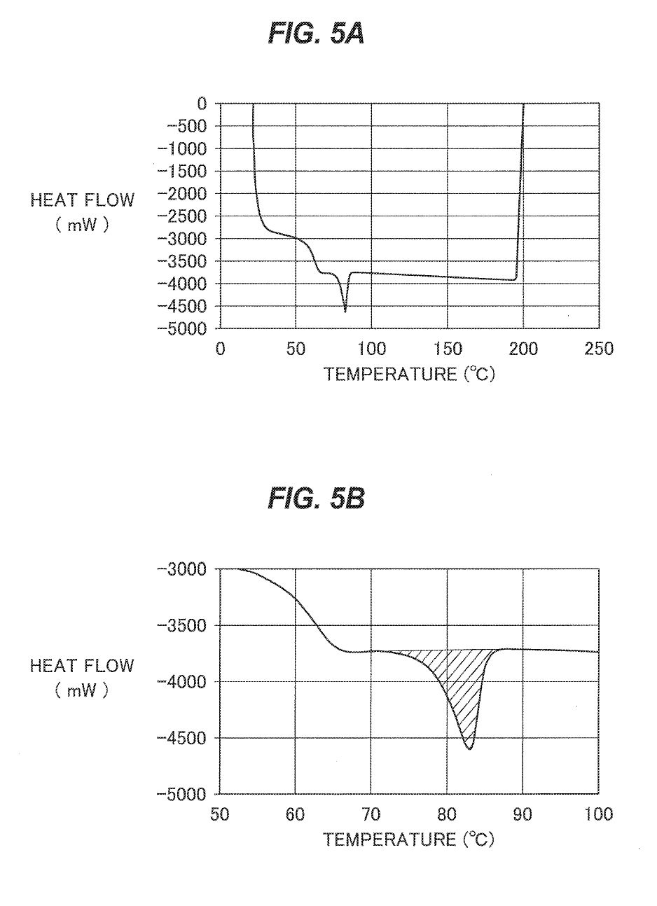

The endothermic amount of the release agent will be described. FIGS. 5A and 5B are endothermic curve graphs illustrating the endothermic curve of the toner J. FIG. 5A illustrates the endothermic curve in the range of 20° C. to 200° C. FIG. 5B is an enlarged graph of a part of the endothermic curve around the endothermic peak at 83° C.

As illustrated in FIGS. 5A and 5B, the endotherm of the release agent is maximum at the peak temperature of 83° C., and the endothermic amount can be obtained by determining the endothermic amount (corresponding to the area of the hatched portion in FIG. 5B) of the release agent in this endothermic region. The endothermic amount varies with the amount of the release agent contained in the toner. The greater the amount of the release agent, the greater the endothermic amount. Here, the endothermic peak is in a predetermined range, e.g., in the range of 75° C. to 90° C. inclusive.

For each of the other toners A to I and K to U, the endothermic amount of the release agent was measured in the same manner as above.

The endothermic amount will also be referred to as the DSC endothermic amount.

Further, for the toner J, toner fine powder amounts were measured using a flow particle image analyzer (FPIA-3000S, manufactured by SYSMEX CORPORATION) under the following conditions.

Measurement method: Flat-sheath flow method

Measurement mode: HPF measurement mode

Lens magnification: 20×

Imaging magnification: 40×

Proper measurement range: 0.25 to 100 μm

Sheath liquid: Particle sheath

Number of effective analyses: 10000

Method of preparing measurement solution: Putting 150 mg of the sample (toner J) into a beaker, adding an aqueous dispersant solution to the sample to make the total volume equal to 15 mL, and then performing dispersion treatment on the mixture with ultrasonic wave (100 W) for two minutes to obtain a measurement solution

The measurement revealed that the proportion of particles having particle sizes (or diameters) not greater than 3.021 μm was 15.55% by number, and the proportion of particles having particle sizes (or diameters) not greater than 1.977 μm was 14.24% by number.

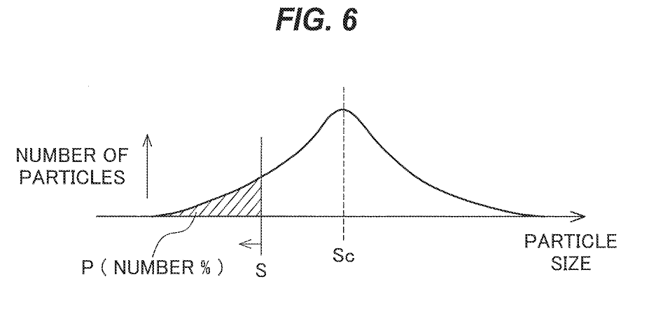

The proportion of particles will be described. FIG. 6 is a graph illustrating the particle size distribution of a toner. The graph has a horizontal axis representing the particle size and a vertical axis representing the number of particles having each particle size. This graph illustrates a distribution characteristic of a toner in which the number of particles having a particle size Sc at substantially the center of the distribution range of particle sizes is the greatest and the number of particles decreases as the particle size decreases or increases from the particle size Sc.

In the toner having the distribution characteristic of FIG. 6, the proportion of particles having particle sizes not greater than S is P % by number. In other words, the ratio of the number of particles having particle sizes not greater than S in the toner (the number of particles in the hatched region of FIG. 6) to the total number of particles in the toner is P %.

For each of the other toners A to I and K to U, the proportion of particles having particle sizes not greater than 3.021 μm and the proportion of particles having particle sizes not greater than 1.977 μm were measured in the same manner as above.

The proportion of particles will also be referred to as the amount of fine particles. The proportion of particles having particle sizes not greater than 3.021 μm (or 1.977 μm) will also be referred to as the amount of fine particles having particle sizes not greater than 3.021 μm (or 1.977 μm).

The toners A to U were sequentially tested for filming. Filming is a phenomenon that toner sticks to a member, such as the developing blade 107, in the image forming unit 25 in the form of a thin film. Filming may cause defects in a printed image, which deteriorates image quality. In particular, if toner sticks to the developing blade 107, it prevents formation of the toner layer on the developing roller 104, thereby causing a line defect on a printed image. Each of the toners A to U was tested using the above-described image forming apparatus 10 as follows.

First, 180 g of toner to be tested was prepared as a test sample and set in the image forming apparatus 10. Then, a printing test was carried out at an ambient temperature of 10° C. and an ambient relative humidity of 20%. In this test, printing was performed on 6000 sheets at a printing duty of 1% in an intermittent printing mode in which continuous printing on 3 sheets and a 12-second pause were repeated. In the continuous printing, sheets were continuously conveyed at a speed of 228 mm/sec with intervals of 60 mm therebetween. Every 1000-sheet printing, a solid image was printed on the entire surface of a sheet, and the presence or absence of image defects in the printed image was determined. Sheets of A4-size plain paper (P paper, manufactured by Fuji Xerox Co., Ltd., having a basis weight of 78 g/m²) were used as the sheets for the printing test. The sheets were conveyed with their long sides along the conveying direction. Based on the solid image printed after 6000-sheet printing, the toner was evaluated as “good” when no defects due to filming were observed in the printed solid image, and “poor” when a defect due to filming was observed in the printed solid image.

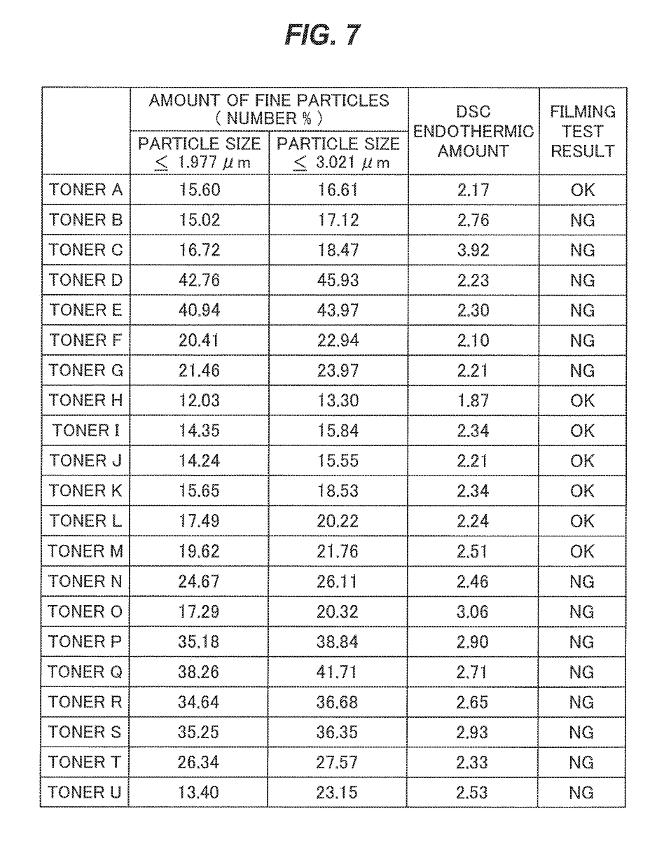

FIG. 7 is a table showing the results of the filming test. The table lists, for each of the toners A to U, the amount of fine particles having particle sizes not greater than 1.977 μm, the amount of fine particles having particle sizes not greater than 3.021 μm, the DSC endothermic amount, and the filming test results.

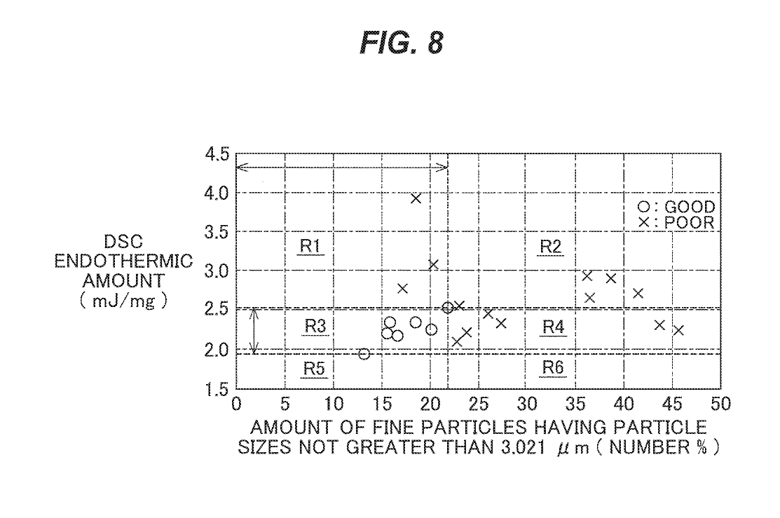

FIG. 8 is a graph plotting the results of the filming test in a coordinate system having a horizontal axis representing the amount of fine particles having particle sizes not greater than 3.021 μm and a vertical axis representing the DSC endothermic amount. The coordinate system is divided by dashed lines into six regions R1 to R6. In FIG. 8, circles indicate “good” and crosses indicate “poor.”

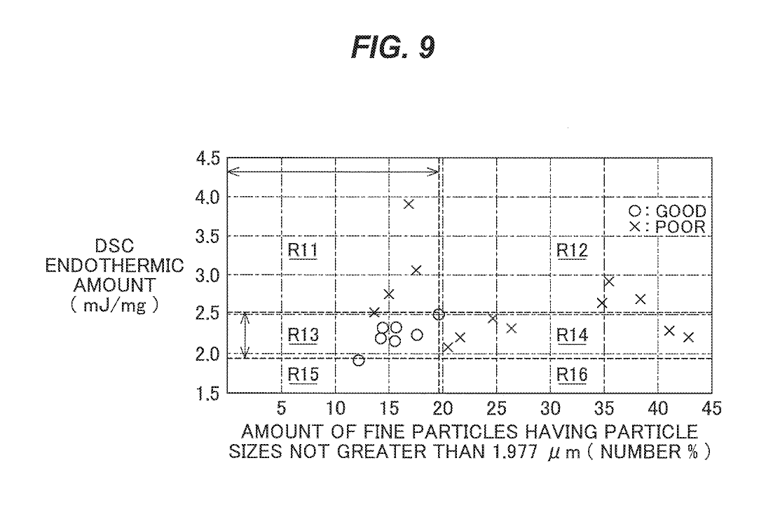

FIG. 9 is a graph plotting the results of the filming test in a coordinate system having a horizontal axis representing the amount of fine particles having particle sizes not greater than 1.977 μm and a vertical axis representing the DSC endothermic amount. The coordinate system is divided by dashed lines into six regions R11 to R16. In FIG. 9, circles indicate “good” and crosses indicate “poor.”

The table of FIG. 7 and the graph of FIG. 8 show that filming can be prevented by using a toner in the regions R3 and R5, i.e., a toner satisfying the following conditions:
the amount of fine particles having particle sizes not greater than 3.021 μm is not greater than 21.76% by number; and
the DSC endothermic amount is not greater than 2.51 mJ/mg.

In the above conditions, the lower limit of the amount of fine particles having particle sizes not greater than 3.021 μm is 0%, which is set in consideration of the fact that the less the amount of fine particles, the better the filming resistance. The lower limit actually confirmed by the test is 13.30% by number, which is the amount of fine particles having particle sizes not greater than 3.021 μm in the toner H.

The table of FIG. 7 and the graph of FIG. 9 show that filming can be prevented by using a toner in the regions R13 and R15, i.e., a toner satisfying the following conditions:
the amount of fine particles having particle sizes not greater than 1.977 μm is not greater than 19.62% by number; and
the DSC endothermic amount is not greater than 2.51 mJ/mg.

In the above conditions, the lower limit of the amount of fine particles having particle sizes not greater than 1.977 μm is 0%, which is set in consideration of the fact that the less the amount of fine particles, the better the filming resistance. The lower limit actually confirmed by the test is 12.03% by number, which is the amount of fine particles having particle sizes not greater than 1.977 μm in the toner H.

The less the additive amount of release agent, which is added to ensure fixability, the worse the fixability. Thus, a fixability test was performed to determine the lower limit of the DSC endothermic amount as described below.

The toner J and a toner Z were prepared as test samples and sequentially tested for fixability. The toner Z was obtained by the same manufacturing method as the toner J except that the amount of release agent of the toner Z is 20% less than that of the toner J.

Each of the toners J and Z was tested using the above-described image forming apparatus 10 as follows.

First, 180 g of toner to be tested was prepared as a test sample and set in the image forming apparatus 10. Then, the image forming apparatus 10 was caused to convey a sheet (Xerox 4200 201b, having a basis weight of 75 g/m²) at a speed of 228 mm/sec and print a block pattern on the sheet while maintaining the surface temperature (referred to below as the fixing temperature) of the fixing roller 36 constant. After the printing, the density Db of a portion of the toner image on the sheet was measured with X-rite 528 (manufactured by X-Rite Incorporated, status I). After that, a piece of Scotch Tape (manufactured by Sumitomo 3M Ltd.) was attached to the portion of the toner image, and the piece of Scotch Tape was reciprocated two times at a speed of 3 mm/sec while being applied with a load of 500 g/12 cm² by a weight from above. Then, the piece of Scotch Tape was removed from the sheet at a speed of 3 mm/sec in parallel with the printed surface of the sheet. After that, the density Da of the portion of the toner image was measured. A fixing rate FR was calculated by the following equation:

FR(%)=(Da/Db)×100.

Based on the calculated fixing rate FR, fixing quality of the toner at the fixing temperature was evaluated as “good” when the fixing rate FR is not less than 90%, and “poor” when the fixing rate FR is less than 90%.

By repeating the above procedure while varying the fixing temperature and evaluating the fixing quality of the toner at different fixing temperatures, a minimum fixing temperature required for good fixing quality was determined as a lower limit temperature.

The fixability test revealed that the lower limit temperature Tj of the toner J was 178° C. and the lower limit temperature Tz of the toner Z was 185° C. In view of safety, it is not preferable that the fixing temperature exceeds 200° C. Thus, the upper limit of the fixing temperature may be set to 200° C. In this case, the range of the fixing temperature in which the toner J can be fixed properly is from 178° C. to 200° C., and the width of the range is 22° C.; the range of the fixing temperature in which the toner Z can be fixed properly is from 185° C. to 200° C., and the width of the range is 15° C. The width of the range of the fixing temperature in which a toner can be fixed properly is preferably not less than 15° C. Thus, the amount of release agent of the toner Z is the lower limit of the amount of release agent. The DSC endothermic amount of the toner Z was measured to be 1.87 mJ/mg.

Thus, to prevent filming and achieve stable toner fixability, it is preferable that the toner 110 satisfy the following conditions:
the proportion of particles having particle sizes not greater than 3.021 μm in the toner is 0% to 21.76% by number inclusive; and
the endothermic amount of the release agent in the toner is from 1.87 mJ/mg to 2.51 mJ/mg inclusive. The above conditions correspond to the region R3 in FIG. 8. By using a toner satisfying the above conditions in printing, it is possible to obtain a good image.

It is also preferable that the toner 110 satisfy the following conditions:
the proportion of particles having particle sizes not greater than 1.977 μm in the toner is 0% to 19.62% by number inclusive; and
the endothermic amount of the release agent in the toner is from 1.87 mJ/mg to 2.51 mJ/mg inclusive. The above conditions correspond to the region R13 in FIG. 9. By using a toner satisfying the above conditions in printing, it is possible to obtain a good image.

It is more preferable that the toner 110 satisfy the following conditions:
the proportion of particles having particle sizes not greater than 3.021 μm in the toner is 0% to 21.76% by number inclusive;
the proportion of particles having particle sizes not greater than 1.977 μm in the toner is 0% to 19.62% by number inclusive; and
the endothermic amount of the release agent in the toner is from 1.87 mJ/mg to 2.51 mJ/mg inclusive. By using a toner satisfying the above conditions, it is possible to more reliably prevent filming and achieve stable toner fixability.

In view of evaluating whether occurrence of filming is likely to lead to defects in a printed image, it is preferable to define the proportion of particles having particle sizes not greater than 3.021 μm. To determine the presence or absence of slight filming on a surface of a member, it is preferable to define the proportion of particles having particle sizes not greater than 1.977 μm.

The above tests were performed under conditions where the pressure P of the developing blade was 28.2 kPa. However, the same results were obtained in the following range:

16.3 kPa≦P≦35.8 kPa.

According to this embodiment, it is possible to provide an image forming unit and an image forming apparatus having excellent filming resistance and fixability.

In the above embodiment, the present invention is applied to an electrophotographic printer, but it is also applicable to other devices, such as a multi-function printer (MFP), facsimile machine, or copier, having an image forming unit.

The present invention is not limited to the embodiment described above; it can be practiced in various other aspects without departing from the invention scope.

What is claimed is:

1. A developing device comprising:
a latent image carrier on which an electrostatic latent image is formed;
a developer carrier that supplies the latent image carrier with developer to develop the latent image formed on the latent image carrier; and
a regulating member that forms a thin layer of the developer on the developer carrier, wherein:
the developer includes a release agent,
an endothermic amount of the release agent in the developer is from 1.87 mJ/mg to 2.51 mJ/mg inclusive, and
a proportion of particles having particle sizes not greater than 3.021 μm in the developer is from 0% to 21.76% by number inclusive.

2. A developing device comprising:
a latent image carrier on which an electrostatic latent image is formed;
a developer carrier that supplies the latent image carrier with developer to develop the latent image formed on the latent image carrier; and
a regulating member that forms a thin layer of the developer on the developer carrier, wherein:
the developer is includes a release agent,
an endothermic amount of the release agent in the developer is from 1.87 mJ/mg to 2.51 mJ/mg inclusive, and
a proportion of particles having particle sizes not greater than 1.977 μm in the developer is from 0% to 19.62% by number inclusive.

3. The developing device of claim 1, wherein a proportion of particles having particle sizes not greater than 1.977 μm in the developer is from 0% to 19.62% by number inclusive.

4. The developing device of claim 1, wherein an endothermic curve of the developer has one or more endothermic peaks in a range of 75° C. to 90° C. inclusive.

5. The developing device of claim 2, wherein an endothermic curve of the developer has one or more endothermic peaks in a range of 75° C. to 90° C. inclusive.

6. The developing device of claim 1, wherein the regulating member is pressed against the developer carrier at a pressure of 16.3 kPa to 35.8 kPa inclusive.

7. The developing device of claim 2, wherein the regulating member is pressed against the developer carrier at a pressure of 16.3 kPa to 35.8 kPa inclusive.

8. The developing device of claim 1, further comprising a charging member that charges a surface of the latent image carrier.

9. The developing device of claim 2, further comprising a charging member that charges a surface of the latent image carrier.

10. The developing device of claim 1, further comprising a developer container that stores developer to be supplied to the developer carrier.

11. The developing device of claim 2, further comprising a developer container that stores developer to be supplied to the developer carrier.

12. The developing device of claim 1, wherein the developer is produced by pulverization.

13. The developing device of claim 2, wherein the developer is produced by pulverization.

14. An image forming apparatus comprising:
the developing device of claim 1;
a transfer unit that transfers the developer supplied to the latent image carrier onto a recording medium; and
a fixing unit that fixes the transferred developer to the recording medium.

15. An image forming apparatus comprising:
the developing device of claim 2;
a transfer unit that transfers the developer supplied to the latent image carrier onto a recording medium; and
a fixing unit that fixes the transferred developer to the recording medium.
